(19) United States
(12) Patent Application Publication
(10) Pub. No.: US 2013/0046571 A1
(43) Pub. Date: Feb. 21, 2013

(54) METHOD FOR PROACTIVELY PREDICTING SUBJECT MATTER AND SKILL SET NEEDED OF SUPPORT SERVICES

(71) Applicants: Kenneth D. Tuchman, Englewood, CO (US); Bruce A. Sharpe, Aurora, CO (US); Henry D. Truong, Chelmsford, MA (US)

(72) Inventors: Kenneth D. Tuchman, Englewood, CO (US); Bruce A. Sharpe, Aurora, CO (US); Henry D. Truong, Chelmsford, MA (US)

(73) Assignee: TELETECH HOLDINGS, INC., Englewood, CO (US)

(21) Appl. No.: 13/213,002

(22) Filed: Aug. 18, 2011

(51) Int. Cl. G06Q 10/00

(52) U.S. Cl. 705/7.14

(57) ABSTRACT

A service center receives information representing user interaction of a user with a presentation while navigating the presentation at a remote device, where the presentation describes a possible solution to a problem related to a product supported by the service center. The service center provides support services for various products on behalf of various product providers. A subject matter of the product is predicted that the user is likely interested in based on the user interaction and one or more skill sets are identified that are required to provide support services for the subject matter of the product, while the user is navigating the presentation. In response to a request received from the remote device requesting a live support, a communications session is established between the user and an agent who qualifies the skill sets to enable the agent to provide live support services to the user.

### FIELD OF THE INVENTION

Embodiments of the present invention relate generally to providing support services. More particularly, embodiments of the invention relate to proactively predicting a subject matter of support services and a skill set required for the same.

### BACKGROUND

Prior to the advent and prolific use of distributed network environments such as the Internet, customer service sessions typically occurred over a teleconference between a customer service agent or service specialist and a customer. These teleconferences, which incidentally are still very popular today, are initiated by a customer placing a phone call to a customer service agent. The customer service agent's phone receives the call through a public-switched telephone network (PSTN). Many support centers handle a large volume of inquiries, usually by phone, for sales, information, customer support and other services. Typical support centers provide the ability to route multiple incoming, customer-initiated calls to agents which provide sales, information, or support on behalf of an entity interested in establishing or maintaining a relationship with the customer.

Modern support center systems selectively route incoming calls based on a number of factors such as the number called or dialed, the originating number, the queued sequence of the caller, the geographic location of the caller, accumulated caller history, and other relevant criteria. Once the system has evaluated the inbound caller's information, if any, the system searches for an available agent to service the call. Availability of agents may be dependent on any number of factors such as a skill level or a schedule of the agent. The number of agents within the contact center and available to the system may often be limited by the physical space available for the agents to operate. Contact centers have to deal with a limited number of agents to handle a large number of incoming customer calls. However, such a skill level may not match a subject matter interested by a customer at the point in time.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating a system for providing life cycle services to products according to one embodiment of the invention.

FIG. 2 is a block diagram illustrating an example of a service center according to another embodiment of the invention.

FIG. 3 is a block diagram illustrating an example of a guided support identification system according to another embodiment of the invention.

FIG. 4 is a diagram illustrating an example of a subject matter and skill set mapping data structure according to one embodiment of the invention.

FIG. 5 is an example of a processing diagram illustrating a method of determining a subject matter of support services according to certain embodiments.

FIG. 6 is a flow diagram illustrating a method for determining a support subject matter based on user interaction according to one embodiment of the invention.

FIG. 7 is a flow diagram illustrating a method for determining a support subject matter based on user interaction according to another embodiment of the invention.

FIG. 8 is a flow diagram illustrating a method for determining a support subject matter based on user interaction according to another embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some aspects, a service center platform utilizes data collected from a user and an intelligent engine to provide guided support identification and routing in order to get users in need of assistance to a specific skill or expert specialist able to support their request or need. The guided support identification is a system and algorithm allowing several modes to analyze user input of a request such as: 1) site or application navigation data; 2) user typed input; 3) user clicked input; 4) user clicked data filter; and 5) a combination thereof. These modes are used to collect information about a support need, narrowing down the exact request (support topic) with which the user has a support need. Once the support identification is determined by the system, a request and other collected information is then passed to a routing engine solution in an integration of identification and routing to get the user to the right skill or expert specialist able to support their request or need. Pre-identification of any user support need is instrumental in ensuring a user is sent to the right support specialist to service their need. In one example, the support world, several metrics are utilized in order to measure the effectiveness of the interaction with the user. A primary unit of measure is “First Contact Resolution” (FCR). FCR is the measure of resolving the users issue or need in the first contact (voice, chat, other) without the need of the user to call back the service center for assistance on the same problem thus reducing overall support costs.

According to some embodiments, a guided support identification system is implemented within a service center that provides support services to a variety of products or services on behalf of a variety of product or service providers. The guided support identification system is configured to analyze user interaction or behaviors to predict or determine a support subject matter that a user may potentially need. Such a support subject matter may be determined based on user interaction while a user is navigating a presentation provided by a remote device such as a Web site or an application running at a computing device (e.g., mobile device), where the presentation includes information describing a possible solution to a problem of a product or service, which may be related to or similar to a product or service the user is interested in.

The user interaction may be captured (e.g., by a capturing logic integrated within or accessible by the presentation) at the remote device and transmitted to the service center over a network while the user is navigating the presentation at the remote device. Based on the predicted subject matter (also referred to as a support type), a skill set (also referred to as a skill route) that is required to provide support services of the subject matter is identified. When the user subsequently requests a live support, for example, within the same user session (e.g., same browser session or same instance of an application), an agent having the identified skill set is selected to provide support services to the user. The user interaction may be periodically captured and transmitted to the service center during navigation of the presentation. In response, the guided support identification system is configured to automatically update and maintain the subject matter determined based on the latest user interaction prior to the user's request for a live support.

In one embodiment, the user interaction is captured and the subject matter of the potential support is determined automatically without user intervention or knowledge. Based on the user interaction, if the system cannot determine the support subject matter based on the user interaction (e.g., lack of sufficient information), the system may cause the remote device to request further user inputs in an attempt to determine the support subject matter. For example, when the system cannot positively identify a support subject matter based on the user interaction, the system may cause the remote device to present one or more predetermined queries and to prompt the user for a response. A query may include one or more questions that the user can enter an answer in an input field of a query page. Alternatively, the query may include one or more selectable items. The user response to these queries can be utilized by the system to further narrow down the user intent in an attempt to determine the possible support subject matter. As a result, the guided support identification system is able to get users in need of assistance to a specific skill or export specialist that is able to support their request or need, even before the user initiates a live support.

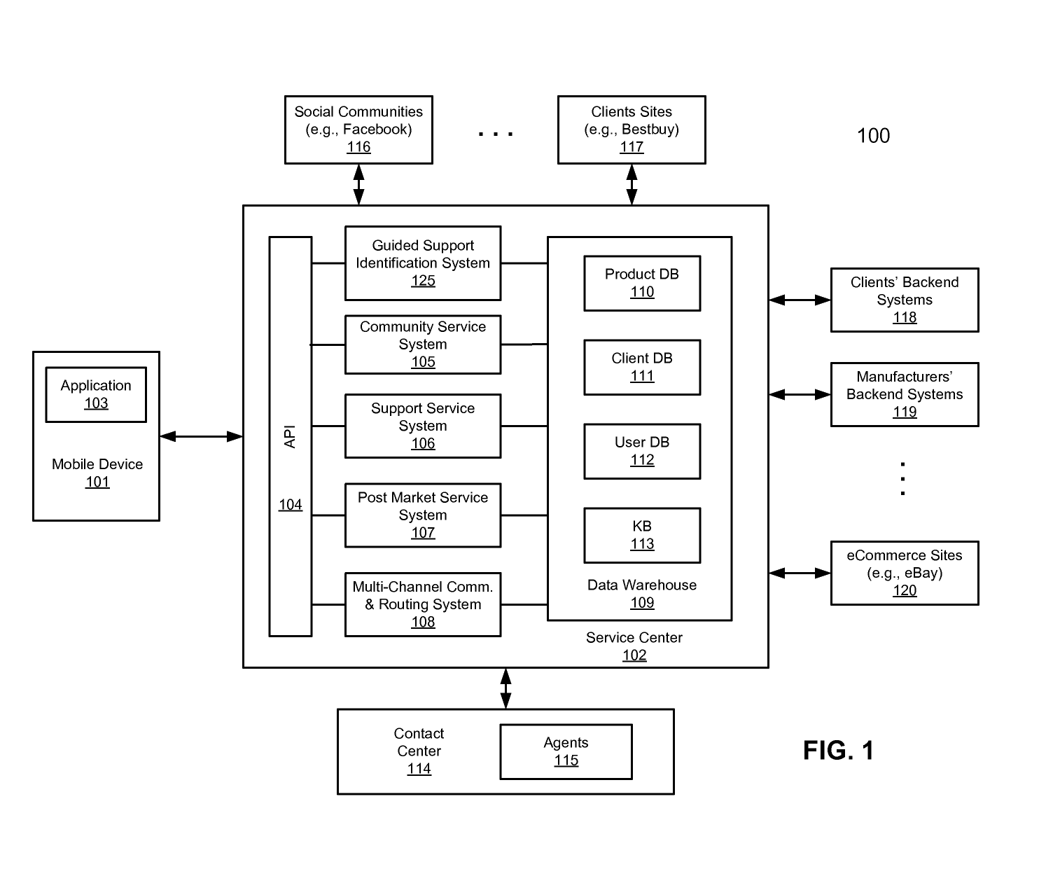

FIG. 1 is a block diagram illustrating a system for providing life cycle services to products according to one embodiment of the invention. Referring to FIG. 1, system 100 includes a mobile device 101 of a user, customer, or individual communicatively coupled to service center 102 over a network. The network may be any kind of networks. Mobile device 101 may be any kind of mobile devices including, but is not limited to, a laptop, mobile phone, tablet, media player, personal digital assistant or PDA, etc.

Service center 102 may be implemented in a centralized facility or server. Alternatively, service center 102 may be implemented in multiple facilities or servers in a distributed manner (e.g., cloud-based service platforms). Service center 102 provides services to a variety of products or services from a variety of clients or vendors. A client may be a manufacturer, a distributor, a retailer, a service provider or broker, a purchasing facility (e.g., Amazon™, Expedia™, or ISIS™), or a combination thereof. In one embodiment, service center 102 includes service APIs 104 to communicate with other systems such as mobile device 101, client's site 117, social communities 116, contact center 114 including agents or experts 115, client backend systems 118, manufacturer backend systems 119, eCommerce sites 120 and other auxiliary systems (e.g., billing system). Service center 102 can handle service requests from customers of multiple clients. For example, a service center may handle customer service requests for a number of retail sales companies, sales calls for catalog sales companies, and patient follow-up contacts for health care providers. In such a structure, the service center may receive service requests directly from the customers or through client support management systems.

In one embodiment, service center 102 further includes community service system 105, support services system 106, post market service system 107, and data warehouse 109. Support services system 106 is responsible for handling support services requests from the users, including identifying and registering a product, creating an instance case context, selecting and assigning a customer representative (also referred to herein as an agent, specialist, or expert) to provide support services to the users, and managing work flows, etc. An agent may be selected based on a skill set or expertise of the agent, as well as other factors such as geographic location, of the agent. The term “agent,” “specialist,” or “expert” refers to a service center personnel or a computerized application, in some cases, that respond to customer requests. An agent may be locally situated at the service center or remotely situated over a network. Throughout this application, the terms of “agent,” “specialist,” and “expert” are interchangeable terms dependent upon the circumstances. In most cases, the term of “agent” collectively refers to a customer representative, a support agent, a support specialist, a support expert, or a combination thereof, which may be a service center personnel and/or a computerized application. Further detailed information concerning service center 102 and/or support service system 106 can be found in co-pending U.S. patent application Ser. No. 13/085,397, filed Apr. 12, 2011, which is incorporated by reference in its entirety.

In one embodiment, community service system 105 is responsible for communicating with social communities 116 via an API, for example, to post a message received from a user and to route the responses received from social communities 116 back to the user. Post market service system 107 is responsible for handling post market activities associated with the registered products, including selling a registered product on eCommerce sites 120 and arranging a disposal facility to dispose or recycle the product, etc.

According to one embodiment, in addition to registering a product with the service center, a user can also register, for example, through the application running within a mobile device, one or more social communities and/or one or more eCommerce sites by storing the necessary credentials (e.g., usernames and passwords) of the servers hosting the social communities and eCommerce sites in a database (e.g., user database) of the service center, where the database is associated with a user the mobile device. Subsequently, the user can transmit a sales request to sell or dispose a registered product by specifying one or more of the eCommerce sites.

In response to the sales request, post market service system 107 of service center 102 is configured to retrieve the necessary credentials for the specified one or more eCommerce sites and arrange the specified eCommerce sites for selling the product together with the associated credentials to allow the eCommerce sites to authenticate the user for the purpose of selling the product, such that the user does not have to provide the necessary credentials at the point in time of the sales request and the user does not have to provide detailed information of the product to be posted on the eCommerce sites describing the product to be sold. A single sales request received from the mobile device can specify multiple eCommerce sites. The service center can also arrange a disposal facility to dispose (e.g., recycle) a registered product without having a user to specifically contact the disposal facility.

Similarly, a user can also post a message to one or more of the registered social communities from the application running within the mobile device without having to individually access the social communities. In one embodiment, a user can transmit a request from mobile device 101 to service center 102, where the request includes a message to be posted and one or more community identifiers identifying one or more registered social communities. In response, community service system 105 of service center 102 is configured to retrieve the associated credentials from the database and to post the message to the specified social communities together with the associated credentials allow the social communities to authenticate the user, without having to prompt the user for the same credentials. Further detailed information concerning community service system 105 and/or post market service system 107 can be found in co-pending U.S. patent application Ser. No. 13/185,213, filed Jul. 18, 2011, which is incorporated by reference herein in its entirety.

In one embodiment, service center 102 further includes a messaging or advertisement system (not shown) responsible for handling any messages received from a variety of partners or parties, such as client sites 117, client backend systems 118, manufacturer backend systems 119, and eCommerce sites 120. Messages may be related to the registered products of the user, such as, promotions, rewards, and recall messages. Messages may include advertisements from a variety of advertisement providers.

In one embodiment, a user can configure a set of one or more rules to specify whether certain types of messages or advertisements received from vendors or parties (e.g., retailers, manufacturers, social communities, or other advertisement providers), which may or may not be related to a registered product, should be routed to the user. These rules serve as part of message delivery or filtering rules. The service center engages with the related parties to allow the related parties to get in touch with the user by sending certain messages such as product promotions, rewards, and/or recalls, etc. to the user. The service center may send a message to a user via one or more communications channels preferred by the user, which may also be configured as a set of rules and stored in a database associated with the user.

According to another embodiment, an advertisement received from a vendor is delivered by the service center to a mobile device of a user based on a set of delivery rules associated with the user. The advertisement is displayed on a display of the mobile device by an application running therein. In addition, the service center and/or the application are configured to track interactions of the user with respect to the displayed advertisement to determine user behaviors, patterns, or trends in view of the displayed advertisement. An analysis is performed on the user interaction and the result of the analysis may be utilized to configure further advertisement delivery by the service center and/or the vendors.

According to another embodiment, service center 102 is configured to identify users that have at least one common product registered with the service center and are also members of a social community. The service center is configured to send a message to those users to invite them to connect (e.g., becoming friends or following a friend) with each other via the social community. The social community is hosted by a third party and communicatively coupled to the service center over a network. The service center may also deliver messages or items posted by one of those users to another one of those users on behalf of the social community, without requiring such users to individually or directly accessing the social community. The service center can also deliver messages or items to a particular user posted by other users of the social community, where the messages or items are related to a registered product of that particular user.

According to a further embodiment, an application running on a mobile device provides a user friendly graphical user interface (GUI) to allow a user to configure a set of one or more delivery rules concerning whether certain types of messages or advertisements should be received at the mobile device from a service center. The service center is configured to deliver messages or advertisements on behalf of a message or advertisement provider, which can be a client to the service center, a retailer, a manufacturer, a social community, or other content providers. A user can utilize the GUI to configure, for each of the providers, whether a message associated with a particular registered product of the user or all products in general related to the provider should be received by the mobile device. The settings of the delivery rules are then transmitted from the mobile device to the service center to allow the service center to deliver subsequent messages or advertisements on behalf of the message or advertisement providers accordingly. Further detailed information concerning the advertisement system can be found in co-pending U.S. patent application Ser. No. 13/185,309, filed Jul. 18, 2011, which is incorporated by reference herein in its entirety.

In one embodiment, data warehouse 109 includes product database 110, client database 111, user database 112, and knowledgebase 113. Product database 110 is configured to store any data related to the registered products including user manuals, etc. Client database 110 is configured to store information related to clients such as client's preferred communications mechanisms. User database 112 is used to store information related users, such as, for example, registered products associated with a user, communications channel preference of a user, credentials necessary for a user to access other sites, and/or messaging filtering settings of a user, etc. Knowledgebase 113 is used to store knowledge collected and compiled over a period of time, which can be used by agents 115 and/or users for self-support purposes.

In one embodiment, service center 102 further includes a multi-channel communication and routing system 108 to provide one or more communication channels to any user or client to concurrently access service center 102. Examples of communication channels include email, chat, texting (e.g., short messaging services or SMS), voice (e.g., automated IVR, real-time, or VoIP), video, Web (e.g., Web conferencing), and/or online community forum (e.g., Facebook™ or Twitter™), etc. Note that the multi-channel communication and routing system 108 may be fully or partially integrated with service center 102 or alternatively, it may be maintained or provided by a third party or partner (e.g., communicatively coupled via service API 104 over a network). Service center 102 further includes an automatic caller distribution (ACD) system (not shown) to receive, route, and manage voice calls exchanged via the multi-channel communication system. A customer can obtain support services from service center 102 via a variety of communication mechanisms. A customer can initiate a support request to contact a live agent such as agents 115 in a live manner. Alternatively, a customer may browse certain knowledgebase, such as KB 113 via a Web interface, in an attempt to find a solution to a problem of a product he/she purchased from a manufacturer via a client of service center 102.

According to one embodiment, service center 102 further includes guided support identification system 125 configured to analyze user interaction or behaviors to predict or determine a support subject matter that a user may potentially need. Such a support subject matter may be determined based on user interaction while a user is navigating a presentation provided by a remote device such as a Web site or an application running at computing device 101, where the presentation (e.g., application 103) includes information describing a possible solution to a problem of a product or service, which may be related to or similar to a product or service the user is interested in.

The user interaction may be captured (e.g., by a capturing logic integrated within or accessible by the presentation) at the remote device and transmitted to guided support identification system 125 over a network while the user is navigating the presentation at remote device 101. Based on the predicted subject matter (also referred to as a support type), a skill set (also referred to as a skill route) that is required to provide support services of the subject matter is identified. When the user subsequently requests a live support, for example, within the same user session, an agent having the identified skill set is selected to provide support services to the user. The user interaction may be periodically captured and transmitted to the service center during navigation of the presentation. In response, guided support identification system 125 is configured to automatically update and maintain the subject matter determined based on the latest user interaction prior to the user's request for a live support.

As a result, the guided support identification system is able to get users in need of assistance to a specific skill or export specialist that is able to support their request or need, even before the user initiates a live support. Once the support subject matter and the required skill set have been identified, a route context (e.g., touch plan) can be generated by support service system 106 as described in the above incorporated-by-reference applications, where the routing context includes all the necessary information an agent needs in order to provide the best support services to the user. A communications session is then established by multi-channel communications and routing system 108 and the routing context is routed to the selected agent.

According to one embodiment, application 103 is installed on mobile device 101 of a customer or user, where application 103 can serve as a central service point to service center 102 that provides support services to a variety of products or services provided by a variety of vendors. The vendors can be, for example, manufacturers, distributors, retailers, service brokers, purchasing houses, etc. of the products. Vendors may be the clients of service center 102 or entities having a business relationship with service center 102. A user (also referred to herein as a customer) can activate application 103 from the user's mobile device 101 to reach agents 115 the service center 102 or KB data center 113 via a variety of communication channels or media, such as, for example, email, chat, voice (including automated interactive voice recognition or IVR, voice over Internet protocol or VoIP), video, Web, and/or online community-based forum, etc. Application 103 can be a thin/thick client application or a Web-based application.

Note that a service center described throughout this application is not limited to a traditional service center or support center, nor is it implemented in a single physical location. A service center described herein represents a collection of service logic or providers communicatively coupled to each other over a network in a distributed or a cloud-based fashion. The term of a service center herein represents any kind of service providers that provide a variety of services to customers or users. As described throughout this application, a service center can be a set of enabling cloud-based service APIs, which enable a variety of consumer product services and support offerings via an intelligent set of technologies providing automated and/or live communications. In one embodiment, services provided by a service center can include, but not limited to: 1) user, product, and loyalty registration and support services; 2) product wish list, reviews, and comparisons; 3) purchasing and accessorizing services; 4) social community support and integration services; 5) intelligent knowledge support services; and 6) integrated sales and product disposition services, etc.

Also note that an agent, an expert, or a customer representative described throughout this application is not limited to a real person. The term of an agent, an expert, or a customer representative can also refer to any processing logic or functional block that is configured or programmed to provide automated services to a customer, for example, via services APIs of the service center, without a need of a real person involved. Such processing logic and/or functional blocks can be implemented in software, hardware, or a combination thereof.

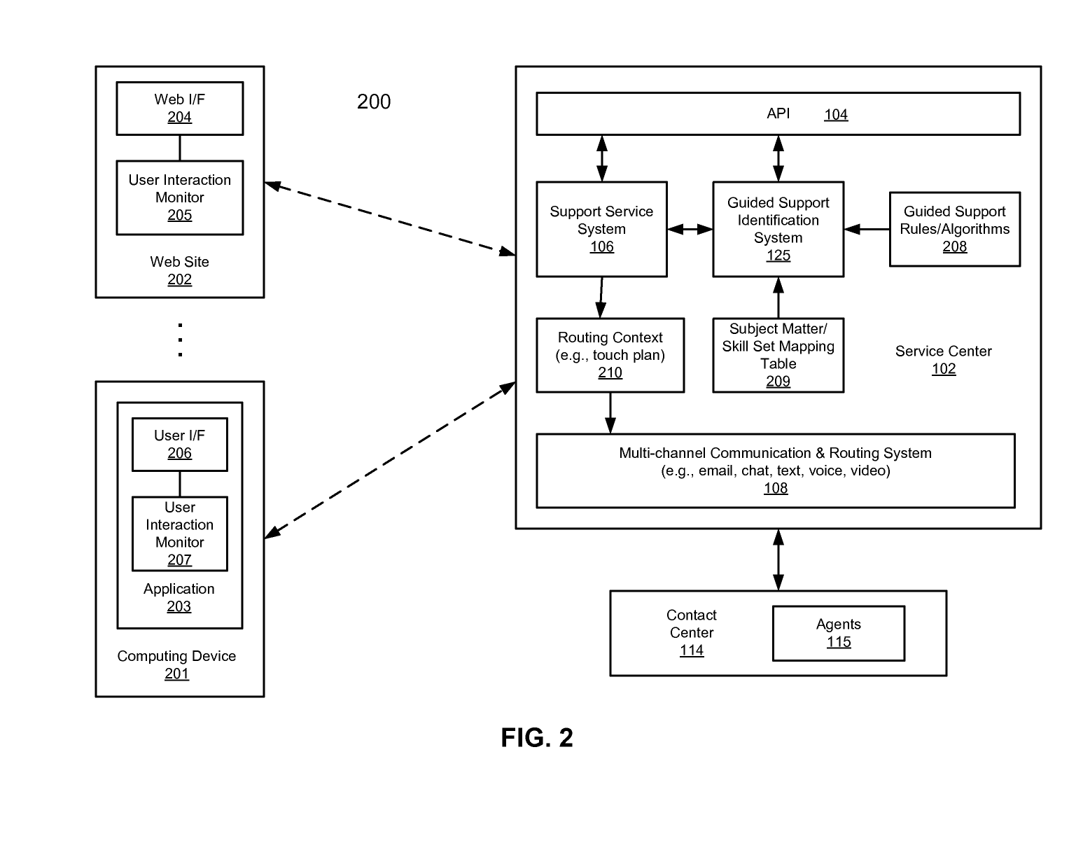

FIG. 2 is a block diagram illustrating a guided support identification system according to one embodiment of the invention. System 200 may be implemented as part of system 100 of FIG. 1. Referring to FIG. 2, service center 102 includes API 104 to allow remote devices such as device 201 or Web server 202 to access resources or services provided by service center 102 over a network. Device 201 may be implemented as part of device 101 and application 203 may be implemented as part of application 103 of FIG. 1. User interaction monitor 207 is configured to monitor and capture user interaction with a representation via user interface 206. A presentation may be an article describing a possible solution to a problem of a product that may be related to a product of the user. For example, a presentation may be retrieved from a self-support knowledgebase such as KB 113 of FIG. 1. Similarly, a user may browse a Web page presented via Web interface 204 of Web site 202 to attempt finding a solution to its problem. User interaction with the Web page may be monitored and captured by user interaction monitor 205. Web site 202 may be implemented as part of client's Web site such as client's sites 107 of FIG. 1. Alternatively, Web site 202 may be maintained by service center 102 via a Web interface.

Typically, a user may want to browse the self-support knowledgebase in an attempt to find a solution to a product of its own. When the user cannot find a solution from the presentation or cannot fully understand the presentation, the user may want to initiate a live support service with an agent. During navigation of the presentation and prior to initiating a live support, for the purpose of illustration only, user interaction monitor 205 is configured to monitor and capture user interaction with the presentation and to transmit the captured user interaction to service center 102. The captured information may further include information identifying the article or subject matter of the article being navigated and/or specific sections, links, or paths within the article that the user interacts, as well as user actions (e.g., information searched, click, tap, or entered in an input field), etc.

In response to the user interaction received via API 104, guided support identification system 125 is configured to analyze the user interaction to determine a subject matter or support type that the user may potentially need based on guided support rules or algorithms 208. In one embodiment, guided support rules 208 are specifically configured and tailored to content of a presentation presented at the remote device, a subject matter, links, or paths of the presentation, and/or a client associated with the presentation (e.g., a product provider of a product described in the article). Once the support type has been determined, guided support identification system 125 is configured to determine a skill set that is required to provide support services associated with the support type. In one embodiment, guided support identification system 125 accesses support type-skill set mapping table 209 to identify a skill set based on the support type. Such a skill set is identified and updated based on user interaction periodically received from the remote device.

When the user requests a live support service, according to one embodiment, support service system 106 is configured to generate routing context 210 that includes all the necessary information concerning the support service needed, user, associated product, associated client or manufacturer, as well as the required skill set to provide such a support service. Routing context 210 is provided to multi-channel communications and routing system 108, which will select an agent that possess the required skill set and route the routing context to the selected agent to be displayed on the agent's desktop. A communications session is then established between the user and the selected agent using a communications channel that is preferred by both the user and the client, which may be configured previously.

Thus, guided support identification system 125 is a system hosting an algorithm to analyze the data as a means of pre-disposition of the users request to get them to the right route (or skill) the first time without all of the common problems experienced in today's support environments such as sending a user to an inexperienced specialist to handle a complex problem, having the user transferred to another skill due to an improper route, having to conference another specialist (usually a higher cost individual) to support the user, or placing a user on hold for long periods of time while trying to contact the proper specialist to handle the interaction. In one embodiment, the user does not have to be prompted to select a channel. The system can be preconfigured to determine the channel along with the route (skill) that the user will be sent down for their support needs.

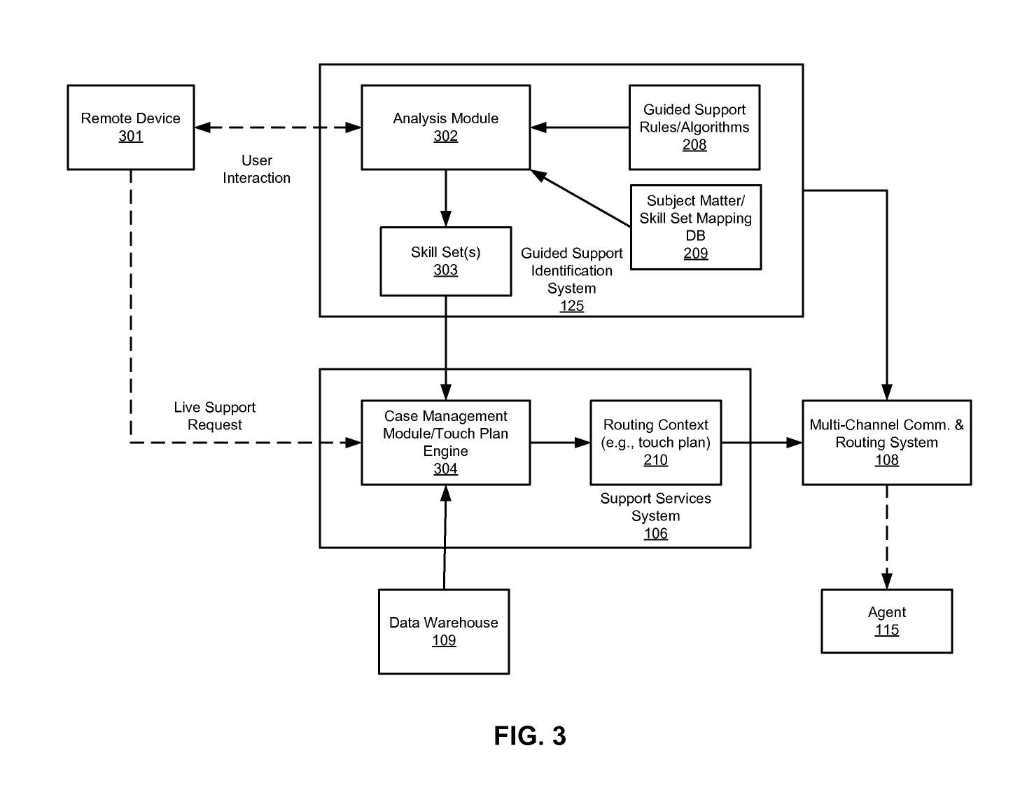

FIG. 3 is a block diagram illustrating an example of a guided support identification system according to another embodiment of the invention. Referring to FIG. 3, in one embodiment, guided support identification system 125 includes analysis module 302 to analyze user interaction with a presentation which may be captured at remote device 301. Remote device 301 may be a mobile device having an application running therein or a Web server hosting a Web page. The presentation presented by the application or Web page may include information describing a possible solution to a problem related to a product or service. In response to the user interaction, analysis module 302 is configured to analyze and determine a support subject matter (e.g., support type) based on guided support rules or algorithms that the user may be interested in.

Guided support rules or algorithms 208 may be designed and configured specifically tailored to the representation currently navigated by the user at remote device 301. For example, guided support rules or algorithms 208 may specify the overall support subject matter for the topic of the presentation. Guided support rules or algorithms 208 may also include specific support subject matters for different parts, links, or paths within the presentation. When a user interacts with different portions of the presentation, it may yield a different support subject matter. In one embodiment, the captured user interaction may further include an amount of time the user has spent on a specific section of the presentation. Such an amount of time may be utilized as a weight factor in deciding which of the support subject matters will prevail.

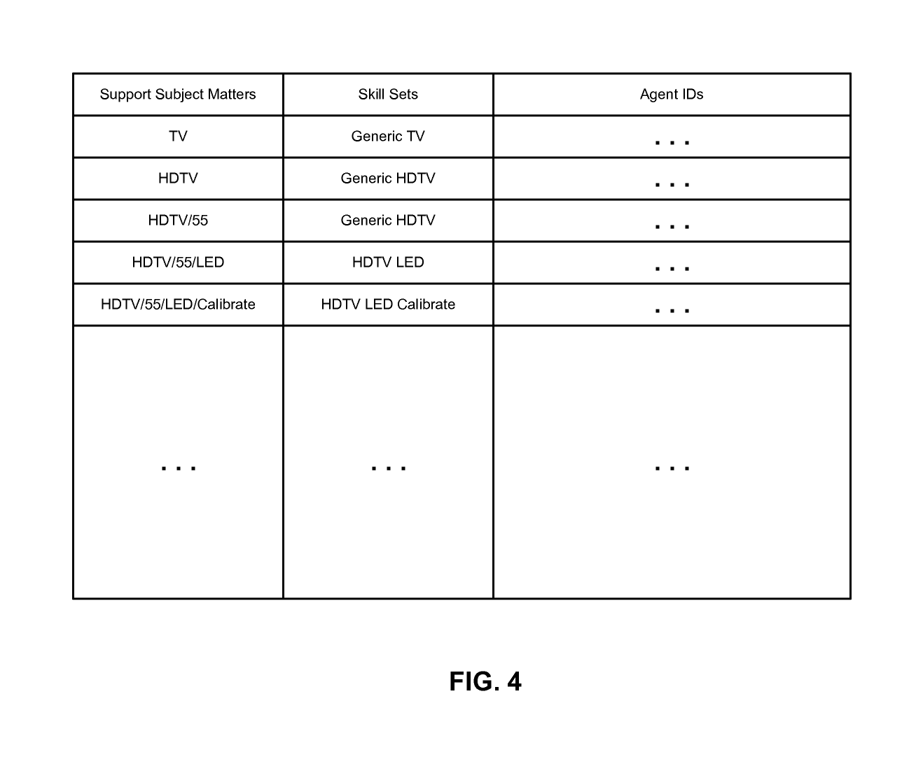

Once the support subject matter has been determined, analysis module 302 is configured to determine one or more skill set 303 that are required to provide the associated support services based on support subject matter and skill set mapping database or table 209. Subject matter and skill set mapping table 209 includes information identifying one or more skill sets that are required to provide support services for a particular support subject matter. Subject matter and skill set mapping table 209 may optionally include information identifying one or more agents or specialists that qualify for each of the skill sets. An example of subject matter and skill set mapping table 209 is shown in FIG. 4.

When the user initiates a live support from remote device 301, for example, by activating a support button or control from the presentation after navigating the presentation, a live support request is received by support service system 106. This could be a situation in which after the user has navigated a certain section of the presentation, the user does not quite understand or is not satisfied with the description. The user may want to have a live session with a specialist to further discuss further details. In one embodiment, the live support button was not available in the presentation initially. Based on the analysis of the user interaction, analysis module 302 may determine that the user may wish to have a live support session at a certain point in time. As a result, guided support identification system 125 may cause remote device 301 to present a live support control to the user, which may be in a form of a displayed button, a voice activated control, or a combination of both, to allow the user to initiate a live support session. Guided support identification system 125 may also cause remote device 301 to provide a list of communications options such as voice, chat, email, video, etc. to allow the user to select one or more of the choices to establish a live session with an agent or specialist. The list of communications options may be previously configured based on user preference and client preference, as described in the above incorporated-by-reference patent applications.

In response to the live support request, according to one embodiment, case management module or touch plan engine 304 is configured to compile and generate routing context (e.g., touch plan) 210 based on information from data warehouse 109, including user information, client information, product information, user interaction history, etc. Routing context 210 is then provided to multi-channel communications and routing system 108 to be routed to agent 115, where routing context 210 is presented to agent 115 as part of a screen pop at a desktop of the agent, such that when agent 115 communicates with the user of remote device 301, agent 115 has all the necessary information concerning the user and the product in question. Further detailed information concerning case management module and touch plan engine 304 can be found in the above incorporated-by-reference patent applications.

Note that the configuration as shown in FIG. 3 has been described for the purposes of illustration only; other configurations may also be applied. For example, multi-channel communications and routing system 108 may directly receive skill set 303 from guided support identification system 125 and based on skill set 303, agent 115 who possesses the required skill set is identified by multi-channel communications and routing system 108. Alternatively, multi-channel communications and routing system 108 receives support subject matter determined by guided support identification system 125 and accesses subject matter and skill set mapping database 209 to determine the required skill set and the qualified agent or agents for routing.

According to one embodiment, while the user is navigating the presentation at remote device 301, the user interaction with the presentation is periodically transmitted from remote device and received by analysis module 302. Based on the user interaction, the support subject matter may be periodically determined and skill set 303 may be determined or updated, which may override a previous one. The received user interaction may also be stored in a database of the service center as part of user interaction history. Thus, skill set 303 may be same or different at any moment dependent upon the user interaction at the point in time. Further, skill set 303 may or may not be utilized dependent upon whether the user ends up requesting a live support during the current user session. Thus, the determined skill set 303 may only be utilized during a current user session (e.g., same browser session or same instant of an application). When the current user session ends, the determined skill set may be discarded. When a user initiates a new session, the above operations may be repeatedly performed and a new set of skills may be determined dependent upon the user interaction at the point in time.

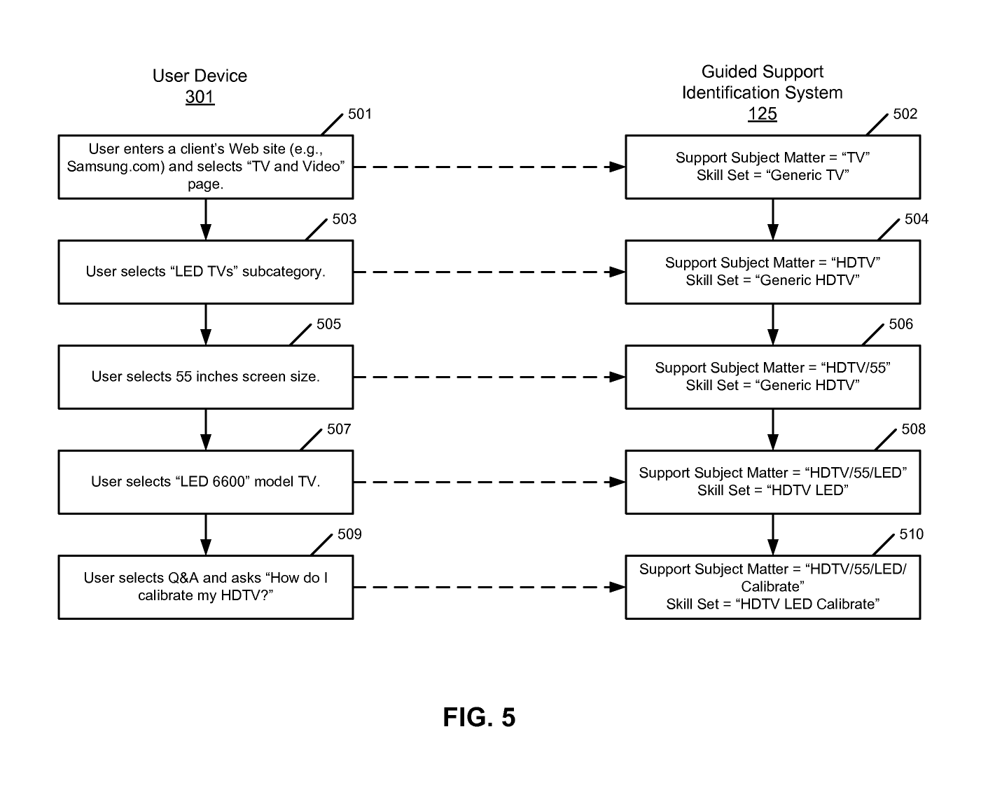

For the purposes of illustration, FIG. 4 is an example of a subject matter and skill set mapping table and FIG. 5 is an example of a processing diagram illustrating a method of determining a subject matter of support services according to certain embodiments. Referring to FIG. 5, at block 501, a user navigates a client Web site and selects a “TV and Video” page. Such a selection is captured by remote device 301 and transmitted to guided support identification system 125. Based on this user interaction, at block 502, guided support identification system 125 determines the support subject matter should be “TV” and the skill set for such the subject matter is “Generic TV” based on the subject matter and skill set mapping table as shown in FIG. 4. At block 503, the user now selects an “LED TVs” category and such a user interaction is captured and transmitted to guided support identification system 125. In response, at block 504, guided support identification system 125 determines that the support subject matter is “HDTV” and the required skill set is “Generic HDTV.” At this point, if the user decides to have a live session, an agent who possesses the required skill set of “Generic HDTV” will be identified and selected to provide live support services to the user. Similarly, if user continues navigating the Web site at blocks 505, 507, and 509, the corresponding support subject matter and the associated skill set are determined at blocks 506, 508, and 510, respectively.

Referring back to FIG. 3, there may be certain situations in which analysis module 302 simply cannot determine a support subject matter based on the received user interaction. That is, the received user interaction may not contain sufficient information to enable analysis module 302 determining the support subject matter. This may happen when a live support request is received by case management module 304 while analysis module 302 is still struggling in determining a support subject matter based on the user interaction. Thus, guided support identification system 125 cannot provide skill set 303 to support services system 106 for identifying a proper agent for routing purposes.

According to one embodiment, when analysis module 302 is unable to determine the support subject matter based on the received user interaction, analysis module 302 may cause remote device 301 to present a query (e.g., visual or audio) requesting further user input in an attempt to further narrow down the intent of the user. In one embodiment, analysis module 302 may cause remote device 301 to present one or more questions to narrow the scope of the request for proper route determination. Based on user's answer entered in an input field and received by analysis module 302, support subject matter may be determined further based on the user answers. According to another embodiment, analysis module 302 may cause remote device 301 to display a page (or audio instructions) having a set of selectable descriptive items. Based on user selection of one or more of the items, analysis module 302 can narrow down the scope of the user intent and determine the support subject matter. According to further embodiment, a list of sequential queries, similar to a data filter, may be presented to the user, where a subsequent query may be selected and presented dependent upon the answer of a previous query. The line of questioning may continue until the subject matter can be ascertained or until a number of questions presented exceeds a predetermined threshold.

Setup for guided support rules 208 and/or subject matter/skill set mapping 209 may include a multi-step process which requires a thorough understanding of the support domain(s) to be serviced. A domain expert of an organization may need to provide the necessary metadata for given products, services, etc., with which the information will be loaded into guided support identification system 125. The data would be associated to a specific client and/or project in which a users application (mobile or Web) will be communicating. The application (mobile or Web) will have to be identified by a client such that the support system leverages the correct client data when the application calls guided support identification system 125 to analyze the users feedback. The support system will also have to have support types defined which will be mapped to the routers specialist skills for the support subject matters. Setup for routing to a support specialist may be done after the guided support identification setup has been completed. Skills will need to be created for mapping to the appropriate support subject matters of the guided support identification system. Agents trained to service the skill/support subject matter are to be assigned to the skill sets. Attention is also taken in regard to long support queue times by adding additional specialist skills as overflow groups.

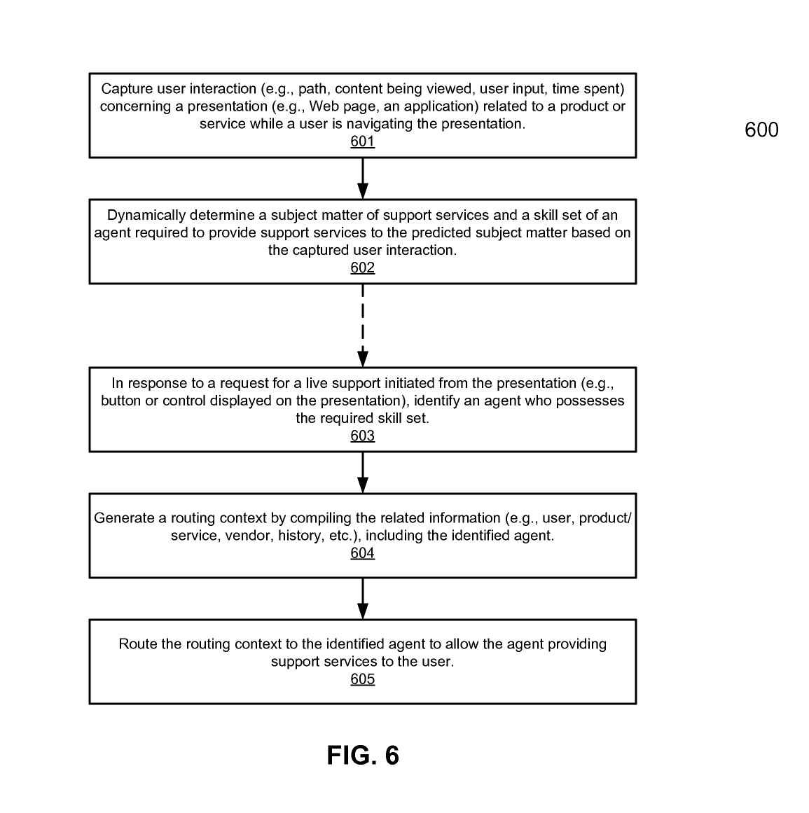

FIG. 6 is a flow diagram illustrating a method for determining a support subject matter based on user interaction according to one embodiment of the invention. Referring to FIG. 6, at block 601, user interaction with a presentation (e.g., a Web page or an application) is captured. The presentation may be related to a possible solution of a product, while a user is navigating the presentation. For example, the user may access a self-support knowledgebase site in an attempt to find a solution without having to contact an agent for a live support session. The user interaction may be captured at a device (e.g., mobile device or Web site) that hosts the presentation. At block 602, the captured user interaction is dynamically transmitted to a service center and the service center is configured to determine a support subject matter of the support services that the user may potentially need based on the user interaction, as well as a skill set of an agent that is required to provide such support services. Operations involved in blocks 601-602 may be iteratively performed while the user is navigating the presentation (e.g., different user interaction). Subsequently, in response to a request for a live support initiated from the presentation at block 603, an agent is identified who possesses the required skill set. At block 604, a routing context is generated by compiling the related information such as user, product, client, history information. At block 605, the routing context is routed to the identified agent to allow the agent providing live support services to the user.

As described above, there are several modes that can be utilized to gather information from the user in determining a support subject matter: 1) Web site or application navigation mode; 2) user typed input mode; 3) user clicked input mode; and 4) user clicked data filter mode. Any one or more of these modes may be utilized individually or in combination, dependent upon the specific circumstances and/or client configuration (e.g., cost). The service center is configured to allow full time monitoring of the entire web site or just the support area of a web site for a client. This data is collected real-time and sent to the service center for analysis. The service center will dynamically update the status of determining a “support type” as data arrives. Once the service center has enough data to effectively determine a predetermined accuracy level (e.g., 85-95%) that the correct “support type” has been identified, the service center will tell the web or mobile application where to route a user who has requested live support.

During the navigation mode, in one embodiment, a user accesses a web site or application powered by the service center, walks around the site or application for a period of time looking for an answer to their support issue, and opens a couple documents labeled with what appears to be their issue. The system during the entire session analyzes the click data of the user on the site or application and predicts the “support type” of the user session based on the click data. The system pops up a message to the user displaying the predicted support need and prompts them to click a button (e.g., chat, voice, video, other) to get support. The availability of the communications options may be configured dependent upon client's settings and/or user preferences. In this example, it is assumed that the user clicks the chat button and is connected via a live chat session with a specialist. A specialist receives a screen pop of the customer session, record and support history (if available) and works with the user to answer any and all questions and ends the chat session with the user. The specialist performs wrap up of session and ends. The system captures all session activity and writes to session record for future history, project reporting and analysis.

During the user typed input mode, in one embodiment, a user accesses a web site or application powered by the service center. The user enters a self help knowledge system to locate an article to answer their issue and asks several questions of the self help knowledge system. System during the entire session analyzes the user entered data. The system being fed data determines the “support type” of the user session and pops up a message to the user displaying the determined support need and prompts them to click a button (e.g., chat, voice, video, other) to get support. The availability of the communications options may be configured dependent upon client's settings and/or user preferences. In this example, it is assumed that the user clicks the live voice button and is connected via a live voice session with a specialist. A specialist receives a screen pop of the customer session, record, support history (if available) and is connected to the user. The specialist works with the user to answer any and all questions and ends the live voice session with the user. The specialist performs wrap up of session and ends. The system captures all session activity and writes to session record for future history, project reporting and analysis.

During the user clicked input mode, in one embodiment, a user accesses a web site or application powered by the service center. The user enters a self help knowledge system to locate an article to answer their issue and asks several questions of the self help knowledge system. The system during the entire session analyzes the user entered data and determines that information needs to be collected from the user and presents a page of information for the user to select items from which will assist in the support type identification. The system being fed data determines the “support type” of the user session. The system pops up a message to the user displaying the determined support need and prompts them to click a button (e.g., chat, voice, video, other) to get support. The availability of the communications options may be configured dependent upon client's settings and/or user preferences. In this example, it is assumed that the user clicks the live voice button and is connected via a live voice session with a specialist. A specialist receives a screen pop of the customer session, record and support history (if available) and works with the user to answer any and all questions and ends the chat session with the user. The specialist performs wrap up of session and ends. The system captures all session activity and writes to session record for future history, project reporting and analysis.

During the user clicked data filter mode, in one embodiment, a user accesses a web site or application powered by the service center. The user enters a self help knowledge system to locate an article to answer their issue and asks several questions of the self help knowledge system. System during the entire session analyzes the user entered data and determines that information needs to be collected from the user and presents a question to the user requiring their feedback. Based on the user answer the system will determine the next best question to ask in order to narrow down the proper support type. The system continues to ask questions and collect answers. The system being fed data determines the “support type” of the user session (after a predetermined number of questions). The system pops up a message to the user displaying the determined support need and prompts them to click a button (e.g., chat, voice, video, other) to get support. The availability of the communications options may be configured dependent upon client's settings and/or user preferences. In this example, it is assumed that the user clicks the live chat button and is connected via a live chat session with a specialist. A specialist receives a screen pop of the customer session, record and support history (if available) and works with the user to answer any and all questions and ends the chat session with the user and the specialist performs wrap up of session and ends. The system captures all session activity and writes to session record for future history, project reporting and analysis.

The above modes can be utilized individually or in combination dependent upon specific circumstances and/or client configuration. One mode can be utilized as a backup or complement to another mode. For example, when the system cannot determine a support subject matter during a navigation mode, the system may invoke any one or more of a user typed input mode, a user clicked input mode, and a user clicked data filter mode to further narrow the scope of the intent of the user.

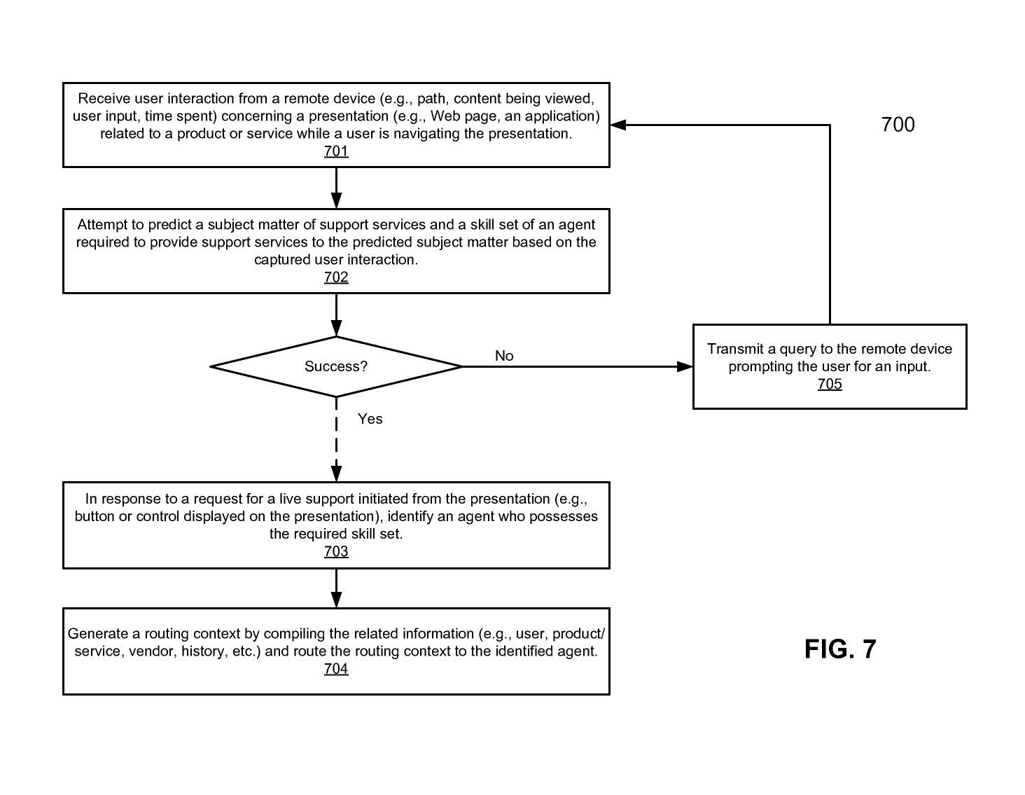

FIG. 7 is a flow diagram illustrating a method for determining a support subject matter based on user interaction according to another embodiment of the invention. For example, method 700 may be performed by guided support identification system 125. Referring to FIG. 7, at block 701, user interaction is received from a remote device, where the user interaction was captured at the remote device while a user is navigating a presentation hosted by the remote device. The presentation may describe a possible solution to a problem of a product or service. At block 702, processing logic attempts to predict a support subject matter (e.g., support type) of support services based on the user interaction and a skill set of an agent required to provide such a support services. If processing logic cannot determine the subject matter based on the user interaction, at block 705, processing logic may invoke another mode (e.g., a user typed input mode, a user clicked input mode, and a user clicked data filter mode) to further narrow down user's intention by transmitting a query to be presented at the remote device prompting for user's input. Subsequently, in response to a request for a live support initiated from the presentation (e.g., activation of a button or control presented via the presentation) at block 703, an agent who possesses the required skill set for the determined subject matter is identified. At block 704, a routing context is generated by compiling all the necessary information and the routing context is then routed to the identified agent for live support.

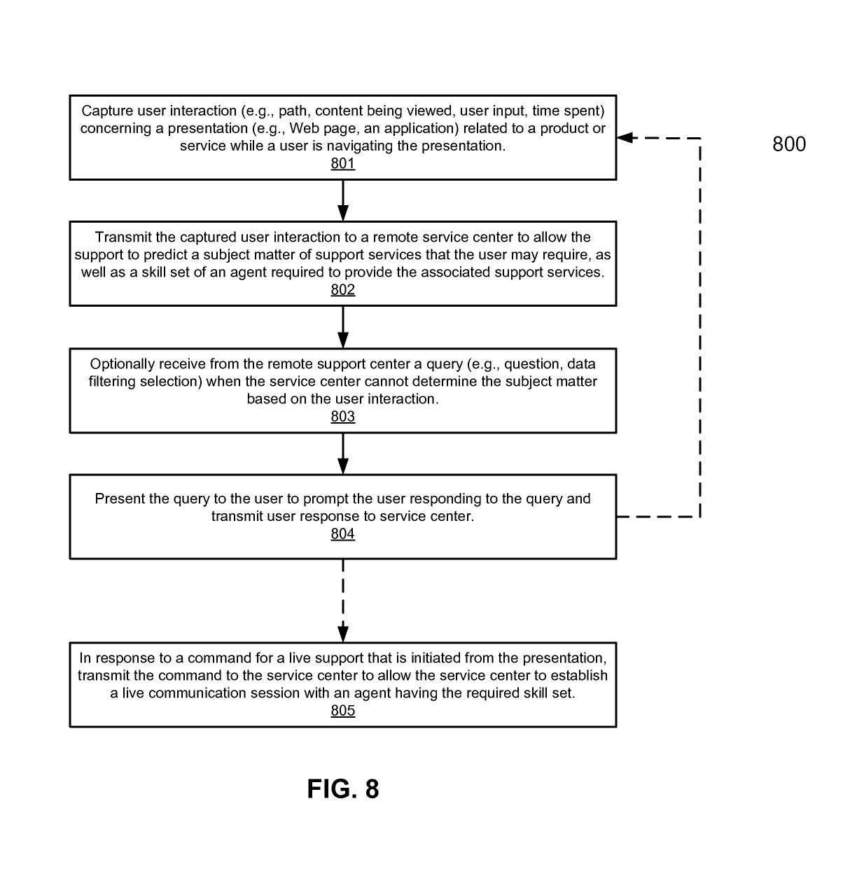

FIG. 8 is a flow diagram illustrating a method for determining a support subject matter based on user interaction according to another embodiment of the invention. For example, method 800 may be performed by an application or Web site hosting a presentation describing a possible solution to a problem of a product. Referring to FIG. 8, at block 801, user interaction with a presentation is captured while a user is navigating the presentation, where the presentation is related to a product or service. At block 802, the captured user interaction is transmitted to a remote service center to allow the service center to predict or determine a support subject matter of support services that the user may potentially need as well as a skill set that is required to provide such support services. At block 803, a query is optionally received from the service center when the service center is unable to determine the support subject matter based on the user interaction. At block 804, the query is presented to the user prompting the user to respond to the query and the response from the user is then transmitted to the service center to enable the service center further narrowing down the user's intent. The operations involved in blocks 801-804 may be iteratively performed. Subsequently, in response to a command for a live support initiated from the presentation, at block 805, the command is transmitted to the service center to allow the service center to establish a live communications session between the user and an agent having the required skill set.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A computer-implemented method for providing support services to users of products, the method comprising:
tracking, by a guided support identification system executed within a server representing a service center, user interaction of a user with a presentation of a self-support knowledgebase (KB) without involving a live support agent of the support center, while the user is navigating the presentation at a remote device, the presentation describing a possible solution to a problem related to a product supported by the service center, wherein the service center provides support services for a plurality of products on behalf of a plurality of product providers;
predicting, by the guided support identification system, a subject matter of the product that the user is currently interested in based on the user interaction, wherein the subject matter is concurrently predicted while the user is navigating the presentation;
identifying, by the guided support identification system, one or more skill sets that are required to provide support services for the subject matter of the product, wherein the one or more skill sets are concurrently identified while the user is navigating the presentation; and
in response to a request received from the remote device requesting a live support after navigating the presentation, establishing, by a multi-channel communications and routing system running within the server, a communications session between the user and an agent who qualifies the one or more skill sets to enable the agent to provide live support services to the user.

2. The method of claim 1, wherein establishing a communications session comprises:
in response to the request for live support, identifying an agent who possess the one or more skill sets;
generating a routing context by compiling information concerning the user, the product, and prior history of the user; and
transmitting the routing context to the identified agent to be displayed on a desktop of the agent.

3. The method of claim 2, further comprising:
transmitting data representing a plurality of communications channels to the remote device to be displayed at the remote device, wherein the communications channels are preferred by the user and a product provider associated with the product; and
in response to a user selection, establishing the communications session using selected one or more communications channels, including one or more of email, chat, text, voice, and video communications channels.

4. The method of claim 1, wherein operations of the receiving, predicting, and identifying are iteratively performed prior to receiving the request for live support in response to different user interaction on the presentation.

5. The method of claim 1, wherein the user interaction is monitored, captured, and transmitted by a monitoring logic of the remote device periodically while the user is navigating the presentation prior to requesting the live support.

6. The method of claim 5, wherein the request for live support is initiated by activating a control embedded within the presentation navigated by the user at the remote device.

7. The method of claim 1, further comprising:
in response to the request for live support, if the subject matter could not be determined based on the user interaction, transmitting a query to the remote device to prompt the user for input, wherein the query is generated based on the user interaction and the presentation; and
in response a user input from the received query, ascertaining the subject matter based on the user input in view of the query.

8. The method of claim 7, wherein transmitting a query and ascertaining the subject matter are iteratively performed until the subject matter has been determined or a number of iterations exceeds a predetermined threshold.

9. The method of claim 1, wherein the product was registered by transmitting a machine readable code uniquely identifying the product from a mobile device of the user to the service center, wherein the machine-readable code was obtained by scanning the product using a scanner of the mobile device, and wherein the service center is configured to compile the detailed information of the product without the user specifically providing detailed information of the product.

10. A machine-readable storage medium having instructions stored therein, which when executed by a processor, cause the processor to perform a method for providing support services to users of products, the method comprising:
tracking, by a guided support identification system executed within a server representing a service center, user interaction of a user with a presentation of a self-support knowledgebase (KB) without involving a live support agent, while the user is navigating the presentation at a remote device, the presentation describing a possible solution to a problem related to a product supported by the service center, wherein the service center provides support services for a plurality of products on behalf of a plurality of product providers;
predicting, by the guided support identification system, a subject matter of the product that the user is currently interested in based on the user interaction, wherein the subject matter is concurrently predicted while the user is navigating the presentation;
identifying, by the guided support identification system, one or more skill sets that are required to provide support services for the subject matter of the product, wherein the one or more skill sets are concurrently identified while the user is navigating the presentation; and
in response to a request received from the remote device requesting a live support after navigating the presentation, establishing, by a multi-channel communications and routing system running within the server, a communications session between the user and an agent who qualifies the one or more skill sets to enable the agent to provide live support services to the user.

11. The machine-readable storage medium of claim 10, wherein establishing a communications session comprises:
in response to the request for live support, identifying an agent who possess the one or more skill sets;
generating a routing context by compiling information concerning the user, the product, and prior history of the user; and
transmitting the routing context to the identified agent to be displayed on a desktop of the agent.

12. The machine-readable storage medium of claim 11, wherein the method further comprises:
transmitting data representing a plurality of communications channels to the remote device to be displayed at the remote device, wherein the communications channels are preferred by the user and a product provider associated with the product; and
in response to a user selection, establishing the communications session using selected one or more communications channels, including one or more of email, chat, text, voice, and video communications channels.

13. The machine-readable storage medium of claim 10, wherein operations of the receiving, predicting, and identifying are iteratively performed prior to receiving the request for live support in response to different user interaction on the presentation.

14. The machine-readable storage medium of claim 10, wherein the user interaction is monitored, captured, and transmitted by a monitoring logic of the remote device periodically while the user is navigating the presentation prior to requesting the live support.

15. The machine-readable storage medium of claim 14, wherein the request for live support is initiated by activating a control embedded within the presentation navigated by the user at the remote device.

16. The machine-readable storage medium of claim 10, wherein the method further comprises:
in response to the request for live support, if the subject matter could not be determined based on the user interaction, transmitting a query to the remote device to prompt the user for input, wherein the query is generated based on the user interaction and the presentation; and
in response a user input from the received query, ascertaining the subject matter based on the user input in view of the query.

17. The machine-readable storage medium of claim 16, wherein transmitting a query and ascertaining the subject matter are iteratively performed until the subject matter has been determined or a number of iterations exceeds a predetermined threshold.

18. The machine-readable storage medium of claim 10, wherein the product was registered by transmitting a machine readable code uniquely identifying the product from a mobile device of the user to the service center, wherein the machine-readable code was obtained by scanning the product using a scanner of the mobile device, and wherein the service center is configured to compile the detailed information of the product without the user specifically providing detailed information of the product.

19. A data processing system of a service center, comprising:
an application programming interface (API) to receive information representing tracking of user interaction of a user with a presentation of a self-support knowledgebase (KB) without involving a live support agent of the service center, while the user is navigating the presentation at a remote device, the presentation describing a possible solution to a problem related to a product supported by the service center, wherein the service center provides support services for a plurality of products on behalf of a plurality of product providers;
a guided support identification system to concurrently predict a subject matter of the product that the user is currently interested in based on the user interaction and to identify one or more skill sets that are required to provide support services for the subject matter of the product, while the user is navigating the presentation; and
a multi-channel communications and routing system, in response to a request received from the remote device requesting a live support after navigating the presentation, to establish a communications session between the user and an agent who qualifies the one or more skill sets to enable the agent to provide live support services to the user.

20. The system of claim 19, wherein operations of receiving, predicting, and identifying are iteratively performed prior to receiving the request for live support in response to different user interaction on the presentation.

21. The system of claim 19, wherein the user interaction is monitored, captured, and transmitted by a monitoring logic of the remote device periodically while the user is navigating the presentation prior to requesting the live support.

22. The system of claim 21, wherein the request for live support is initiated by activating a control embedded within the presentation navigated by the user at the remote device.
